(19) United States
(12) Patent Application Publication
(10) Pub. No.: US 2018/0245560 A1
(43) Pub. Date: Aug. 30, 2018

(54) Selective deactivation of an internal combustion engine of a motor vehicle by means of an automatic start-stop device

(71) Applicant: GM GLOBAL TECHNOLOGY OPERATIONS LLC, Detroit, MI (US)

(72) Inventor: Klaus Pochner, Ruesselsheim (DE)

(73) Assignee: GM GLOBAL TECHNOLOGY OPERATIONS LLC, Detroit, MI (US)

(21) Appl. No.: 15/907,331

(22) Filed: Feb. 28, 2018

(30) Foreign Application Priority Data
Feb. 28, 2017 (DE) 102017001909.6

(51) Int. Cl. F02N 11/08

(52) U.S. Cl. CPC F02N 11/0837; F02N 2200/123; F02N 2200/125

(57) ABSTRACT

A method and system are disclosed for the selective deactivation of an internal combustion engine of a motor vehicle by an automatic start-stop device. A traffic situation of the motor vehicle is detected. The deactivation is prevented or delayed in the case that the detected traffic situation corresponds to at least one predetermined traffic situation.

### CROSS-REFERENCE TO RELATED APPLICATION

This application claims priority to German Patent Application No. 102017001909.6, filed Feb. 28, 2017, which is incorporated herein by reference in its entirety.

### TECHNICAL FIELD

The present disclosure pertains to a method and control for the selective deactivation an internal combustion engine of a motor vehicle by an automatic start-stop device and to a motor vehicle with the control and to a computer program product for carrying out the method.

### BACKGROUND

Motor vehicles with automatic start-stop device, also called automatic stop-start device or system are known for example from US 2014/379241. According to these methods and systems fuel can be advantageously saved in that the internal combustion engine of the motor vehicle on detecting a predetermined deactivation condition, for example while waiting at red traffic lights or the like. The predetermined deactivation condition may include a clutch disengagement, engagement of a neutral gear and braking such that the engine is automatically deactivated.

However, such automatic start-stop devices can deactivate the internal combustion engine also in situations in which this is undesirable, in particular when the standing time of the motor vehicle is so brief that the subsequent starting of the internal combustion engine results in noticeable delays or interferences, in particular vibrations, noises or the like because of the deactivation and renewed starting outweigh the advantage of the saved fuel in particular subjectively or for the individual driver.

Accordingly, an automatic deactivation can be undesirable when stopping at a stop or yield sign, so-called four-way intersections or the like.

### SUMMARY

In accordance with the present disclosure improved operation of a motor vehicle with automatic start-stop device is provided.

According to an embodiment of the present disclosure, a method for the selective deactivation of an internal combustion engine of a motor vehicle by an automatic start-stop device, includes detecting a traffic situation of the motor vehicle; and preventing or delaying the deactivation in the case that the detected traffic situation corresponds to at least one predetermined traffic situation or such is determined or detected. Thus, fuel can be advantageously saved in an embodiment on the one hand through the automatic start-stop device and at the same time the frequency of an undesirable automatic deactivation reduced.

In an embodiment, the deactivation is delayed by a predetermined, in particular adjustable period of time relative to or compared with a deactivation in the case that the detected traffic situation does not correspond to a predetermined traffic situation or such is determined or detected. In an embodiment, this predetermined period of time amounts to at least 1 second, in particular at least 10 seconds, and/or maximally 120 seconds, in particular preferably 60 seconds. Thus, fuel can be advantageously saved in an embodiment even with erroneous detecting of a (predetermined) traffic situation.

In an embodiment, the traffic situation is detected by one or more optical detectors, in particular one or more cameras of the motor vehicle which or of which at least one is a front-end or forward-focusing camera in an embodiment. By way of such optical detectors, traffic situations, in particular traffic signs, further streets, parking situations of the motor vehicle and/or intermittent movements of traffic travelling ahead can be advantageously, in particular precisely, quickly and/or reliably detected in an embodiment.

In an embodiment, the or at least one of the optical detectors is also used for brightness detection for a lighting control of the motor vehicle, a rain detection for a windscreen wiper control of the motor vehicle and/or a road and/or traffic detection for a driver assistance system of the motor vehicle or is equipped for this purpose. Thus, an optical detectors that is present anyway in an embodiment can advantageously assume a further functionality.

Additionally or alternative to one or more optical detectors, the traffic situation, in an embodiment, is detected with the help of at least one navigation system, in particular a GPS system, of the motor vehicle and/or at least one communication system of the motor vehicle for communicating with traffic travelling ahead, in particular one or more further vehicles travelling ahead, and/or a vehicle surroundings, in particular at least one, in particular reached or approached traffic sign and/or traffic guidance system.

Through the navigation system, traffic signs, further roads, parking situations or the like can be or become advantageously detected in an embodiment, in particular positions assigned to these and/or stopping or waiting times such as for example red phases of traffic lights stored. In this way, stopping or starting or reaching of a traffic light, of a stop sign, of a junction into a street with right of way, a car park, in particular multi-story car park or the like can be detected. Additionally or alternatively, in an embodiment, a (mutual) plausibility check, complementation and/or differentiation of the detection can take place by detecting the traffic situation both with the at least one optical detectors and also with the navigation system and/or communication system for communicating with traffic travelling ahead and/or a vehicle surroundings. In an embodiment, a usual duration of a stopping or waiting time, in particular red light phase stored in the navigation system, and/or a timing of a (last) change-over of the traffic sign detected with the help of the at least one optical detectors or transmitted with the at least one communication system, in particular a last switching of a traffic light to red or the like stored in the navigation system with the help of the at least one optical detectors, of the navigation system and/or of the communication system for communicating with traffic travelling ahead and/or a vehicle surroundings is taken into account in detecting the traffic situation.

In an embodiment, at least one predetermined traffic situation may include a stopping at or reaching or approaching a predetermined stop or wait or yield-commanding traffic sign type. The deactivation may be selectively prevented or delayed differentiated by detected traffic sign type or traffic sign type-specifically, in particular in the case that a stop sign, in particular stop signpost, a yield sign, in particular signpost or the like is reached, approached or the vehicle stopped at such or such is detected. Thus, the frequency of an undesirable automatic deactivation at such traffic signs can be reduced in an embodiment.

In an embodiment, at least one predetermined traffic situation may include a stopping at or reaching at or approaching a stop or wait-commanding traffic sign(s), in particular a traffic light, with a variable expiring stop or waiting time, which is shorter than a specified minimum time which in an embodiment is adjustable and/or greater than 0 seconds, in particular greater than 1 second, and/or smaller than 120 seconds, in particular smaller than 60 seconds, in particular smaller than 30 seconds, in particular smaller than 10 seconds. The variable or remaining stop or waiting time can be detected in an embodiment with the optical detectors, in particular an image evaluation, and/or a communication with the traffic sign or guidance system also known as beacon-to-car communication. As a result, the frequency of an undesirable automatic deactivation at such traffic signs can be reduced in an embodiment.

Additionally or alternatively, at least one predetermined traffic situation may include, a stopping at or reaching of or approaching a stop or wait-commanding traffic sign(s) with static stopping or waiting command, in particular a stop sign, a stop signboard, a yield sign, or the like. Thus, the frequency of an undesirable automatic deactivation at such (static) traffic sign types can be reduced in an embodiment.

Additionally or alternatively, at least one predetermined traffic situation may include a stopping at or reaching of or approaching one or more further roads which have in particular permanently or temporarily right of way, in particular a road intersection such as an all-way stop, a four-way stop, a junction or a traffic circle. Thus, the frequency of an undesirable automatic deactivation in such traffic situations can be reduced in an embodiment. Additionally or alternatively, at least one predetermined traffic situation may include, a parking of the motor vehicle in an embodiment.

Additionally or alternatively, at least one predetermined traffic situation which includes an intermittent movement of a traffic of the motor vehicle travelling ahead, the stoppage time of which in an embodiment is shorter than a specified minimum time. In an embodiment, the stoppage time is adjustable and/or greater than 0 seconds, in particular greater than 1 second, and/or smaller than 120 seconds, in particular smaller than 60 seconds, in particular smaller than 30 seconds, in particular smaller than 10 seconds and/or is brought about by one of the traffic situations of the traffic travelling ahead explained above by a further vehicle directly or indirectly travelling ahead, i.e. in particular by way of stopping at or reaching or approaching a predetermined stop or wait-commanding traffic sign type, in particular a traffic sign with a variable stopping or waiting time, which is shorter than a specified minimum time, or traffic signs with static stopping or waiting command, or a further road which in particular has at least temporarily right of way.

The intermittent movement or the stoppage time of the same can, in an embodiment, be detected by the or one of the optical detectors, and/or a communication with the traffic travelling ahead (so-called car-to-car communication). In particular in such traffic situations, such as a parking, a stop-and-go traffic with short stoppage times or the like, the frequency of an automatic deactivation that is undesirable in this case can be reduced in an embodiment. By taking into account an intermittent movement of a traffic travelling ahead, it is also possible, in an embodiment, to advantageously react to traffic signs or stoppage times brought about by the same, which cannot (yet) be detected by optical detectors of the motor vehicle.

In an embodiment, a stoppage time of the internal combustion engine in at least one of the predetermined traffic situations is probably shorter than a minimum time which in an embodiment is adjustable and/or greater than 0 seconds and/or smaller than 120 seconds, in particular smaller than 60 seconds, in particular smaller than 30 seconds, in particular smaller than 10 seconds. In other words, it is in particular empirically and/or statistically probable or more probable in an embodiment in at least one of the predetermined traffic situation) that the internal combustion engine will already be started again by the automatic start-stop device within the minimum time. Accordingly, deactivation is prevented or delayed in an embodiment in the case that a probability that the internal combustion engine will already be started by the automatic start-stop device within the minimum time exceeds a specified minimum value, in particular at least 25%, in particular at least 50%, in particular at least 75% or such is detected because of the detected traffic situation or determined.

In particular since there may be different reasons as to why an internal combustion engine of a motor vehicle does not react without delay, a deactivation because of an incorrect forecast or effective detection or interpretation of a traffic situation is frequently not or not excessively perceived by the driver and/or is unproblematic because of a corresponding automatic restart by the automatic start-stop device. In an embodiment, the internal combustion engine is deactivated without delay automatically for this reason by the automatic start-stop device on detecting a predetermined deactivation condition provided this is not prevented or delayed because of the detected traffic situation or this is commanded or switched over in a corresponding operating mode for deactivation, and/or on detecting a predetermined starting condition, for example an actuation of a clutch, engagement of a gear and/or releasing of an actuated brake or the like the internal combustion engine (automatically deactivated if applicable with delay by the automatic start-stop device) is automatically started (again) or the automatic start-stop device is equipped to do so. With respect to the functioning of an automatic start-stop device known per se, reference is additionally made to US 2014/379241 mentioned at the outset and the content of the same incorporated in the present disclosure.

In an embodiment, the deactivation is prevented or delayed in the case that the detected traffic situation corresponds to at least one predetermined traffic situation although a predetermined deactivation condition of the automatic start-stop device is present or detected. In an embodiment, a deactivation is commanded by the or through the automatic start-stop device in the case that a predetermined deactivation condition of the automatic start-stop device is detected. This command, in particular its generation, passing on and/or implementation is suppressed or (time) delayed in an embodiment in the case that the detected traffic situation corresponds to at least one of the predetermined traffic situations.

The predetermined deactivation condition may, in an embodiment, include a movement state of the motor vehicle, a stoppage or an undershooting of a predetermined minimum speed, a shifting state, a released or opened clutch and/or an engaged neutral or idle gear, and/or one or more driver inputs, a clutch disengagement, engaging a neutral or idle gear and/or braking or is dependent on this or is vehicle intrinsic. Accordingly, in an embodiment, a detected or predetermined traffic situation is vehicle extrinsically independent of the shifting and/or movement state of the motor vehicle and/or driver inputs and/or in particular only dependent on a vehicle surroundings.

According to an embodiment of the present disclosure, a control device for the selective deactivation of an internal combustion engine of a motor vehicle is equipped by or through an automatic start-stop device by way of hardware and/or software, in particular a program equipped for carrying out a method described here. In particular, the control device is configured to detect a traffic situation of the motor vehicle and prevent or delay the deactivation in the case that the detected traffic situation corresponds to at least one predetermined traffic situation.

In an embodiment, the control device is configured to detect the traffic situation by at least one optical detectors such as for example at least one front-end camera of the motor vehicle, an optical detector for brightness detection for a lighting control of the motor vehicle, a rain detector for a windscreen wiper control of the motor vehicle, and/or a road or traffic detector for a driver assistance system of the motor vehicle. The control device may also be configured to detect the traffic situation using at least one navigation system, in particular a GPS system, of the motor vehicle and/or at least one communication system of the motor vehicle for communicating with traffic travelling ahead and/or a vehicle surroundings, in particular at least one traffic sign and/or guidance system.

The control device may also be configured to detect a stopping at or reaching or approaching a predetermined stop or wait-commanding traffic sign type, and more specifically detecting a stopping at or reaching or approaching a stop or wait-commanding traffic sign, in particular a traffic light, with a variable stopping or waiting time which is shorter than a specified minimum time, and/or detecting a stopping at or reaching or approaching a stop or wait-commanding traffic sign with static stopping or waiting command, in particular a stop sign.

The control device may also be configured to detect a stopping at or reaching or approaching an at least one road which has at least temporarily right of way, in particular a road intersection, junction or a traffic circle. The control device may also be configured to detect a parking of the motor vehicle, or an intermittent movement of a traffic of the motor vehicle travelling ahead, the stoppage time of which in particular is shorter than a specified minimum time and/or brought about by a predetermined traffic situation of the traffic travelling ahead.

The control device is further configured to adjust a specified minimum time mentioned here.

A control device may be configured in terms of hardware and/or software, in particular includes a digital processing unit that is preferably data or signal connected to a storage and/or bus system in particular microprocessor unit (CPU) and/or one or more programs or program modules. The CPU may be configured in order to execute commands which are implemented as a program stored in a storage system, detect input signals from a data bus and/or emit output signals to a data bus. A storage system can include one or more different storage media, in particular optical, magnetic, solid and/or other non-volatile media. The program can be of such a type that it embodies the methods described here or is capable to carry out the same, so that the CPU can execute the steps of such methods and thereby control an internal combustion engine of a motor vehicle. In an embodiment, one or more, in particular all, steps of the method are completely or partly carried out in an automated manner, in particular by the control or its means.

### BRIEF DESCRIPTION OF THE DRAWINGS

The present disclosure will hereinafter be described in conjunction with the following drawing figures, wherein like numerals denote like elements.

FIG. 1 illustrates a part of a motor vehicle with an internal combustion engine and a control according to an embodiment of the present disclosure; and

FIG. 2 is a flow chart showing a method for the selective deactivation of the internal combustion engine according to an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

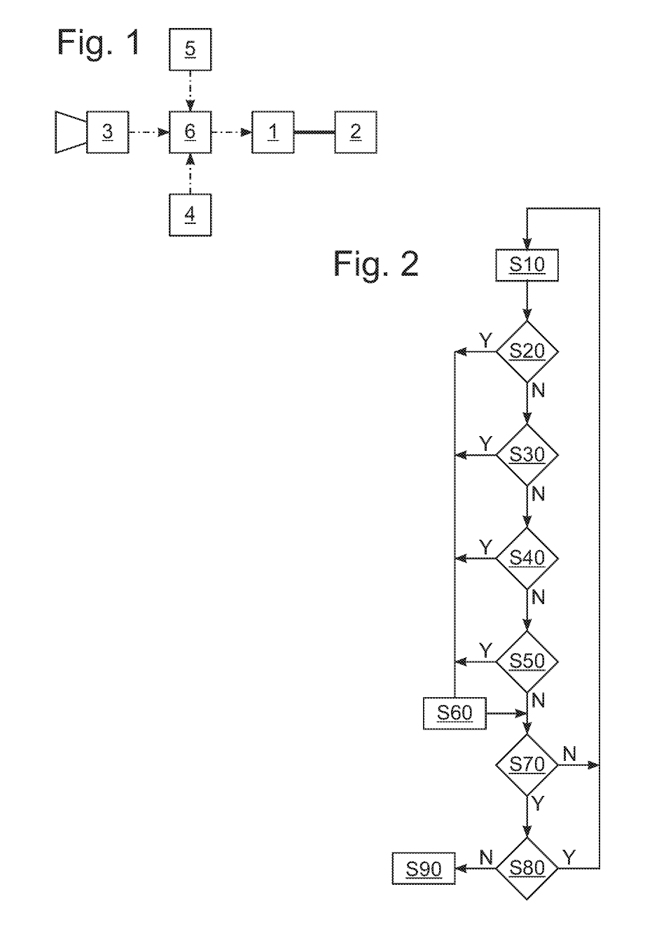

FIG. 1 shows a part of a motor vehicle with an internal combustion engine 1, a gear shift with a clutch and a transmission 2 coupled to the same, a front-end camera 3, sensors 4 for a braking of the motor vehicle and a state of gear shift or clutch and transmission 2, a GPS and/or communication system 5 and a control device 6 configured to control the internal combustion engine having an automatic start-stop device which commands a deactivation in the case that, with the help of the sensors 4, a predetermined deactivation condition is detected. Such deactivation conditions may include a clutch disengagement, engaging a neutral gear and/or a braking.

In the following, the control device 6 carries out a method explained with reference to FIG. 2 for the selective deactivation of the internal combustion engine 1 according to an embodiment of the present disclosure or is equipped to do so.

In a step S10, a traffic situation of the motor vehicle is detected with the help of the front camera 3 and of the GPS and/or communication system 5, in particular traffic signs, traffic lights, traffic travelling ahead and/or a parking of the motor vehicle.

In a step S20 it is checked if the motor vehicle has reached a stop signpost or a similar stop or wait-commanding traffic sign with static stop or wait command and/or an intersection with at least one further road at least temporarily having right of way such as for example an all-way stop or stops at such or approaches such. This can take place for example by traffic sign detection by the front camera 3, the GPS system and/or car-to-car communication 5.

When the motor vehicle approaches a stop sign, an all-way stop or the like or has reached or stops at such (S20: “Y”), it is detected that a stoppage time pending a renewed starting of the internal combustion engine 1 by the automatic start-stop device will probably amount to only a few seconds, or it is probable (or more probable) that the internal combustion engine 1 will be again be started by the automatic start-stop device within a few seconds. For this reason, the method or the control device 6 proceeds with step S60.

Otherwise (S20: “N”) the method for the control device 6 proceeds with step S30 by checking of the motor vehicle has reached or stops at or approaches a traffic light or a similar stop or wait-commanding traffic sign with variable stop or waiting time and the (remaining) stop or waiting time or phase, for example red phase, merely amounts to a few seconds. This can be affected for example by monitoring the traffic light by way of the front camera 3 while approaching or stopping at the traffic light and/or beacon-to-car communication.

If the (remaining) stopping or waiting time merely amounts to a few seconds (S30: “Y”), it is detected in turn that a stoppage time pending a renewed starting of the internal combustion engine 1 by the automatic start-stop device will likewise amount to only a few seconds or it is probable or more probable that the internal combustion engine 1 will again be restarted by the automatic start-stop device within a few seconds. For this reason, the method or the control device 6 proceeds with step S60.

Otherwise, (S30: “N”) the method or the control device 6 proceeds with step S40 by checking if a traffic travelling ahead performs an intermittent movement the stoppage time of which amounts only a few seconds and/or is brought about by a stop signpost located ahead, a junction with a road having right of way or the like, at which the traffic travelling ahead has to briefly stop in each case. This can take place for example by monitoring the traffic travelling ahead by the front camera 3, the GPS system and/or car-to-car communication 5.

If the stoppage time of the intermittent movement of the traffic travelling ahead amounts to only a few seconds or corresponds to a predetermined stop-and-go movement pattern (S40: “Y”), it is detected in turn that a stoppage time pending a renewed starting of the internal combustion engine 1 by the automatic start-stop device will probably likewise amount to only a few seconds or it is probable or more probable that the internal combustion engine 1 will be again started by the automatic start-stop device within a few seconds. For this reason, the method or the control device 6 proceeds with step S60.

Otherwise (S40: “N”), the method or the control device 6 proceeds with step S50 by checking if the vehicle happens to be parking at this time, which can for example be affected with the help of the front camera 3, of the GPS system and such or car-to-car communication for example in the case that a position of the motor vehicle is detected on a car park or the like.

If this is the case (S50: “Y”) it is again detected that a stoppage time pending a renewed starting of the internal combustion engine 1 by the automatic start-stop device will probably likewise amount to only a few seconds or it is probable or more probable that the internal combustion engine 1 will be again started by the automatic start-stop device within a few seconds. For this reason, the method or the control device 6 proceeds with step S60. Otherwise (S50: “N”) the method or the control device 6 directly proceeds with step S70.

In the step S60, a marker is placed or activated which prevents or delayed for a predetermined time a deactivation of the internal combustion engine 1 by the automatic start-stop device. Following this, the method or the control device 6 likewise proceeds with step S70.

In the step S70 it is checked if the predetermined deactivation condition, in the exemplary embodiment the clutch disengagement, engaging of a neutral gear and/or braking is detected. If this is not the case (S70: “N”) the method or the control device 6 returns to step S10.

Otherwise (S70: “Y”), i.e. when the predetermined deactivation condition is present or detected, the automatic start-stop device deactivates the internal combustion engine 1 in a step S90 in the case that the marker, which prevents this, has not been placed or activated (S80: “N”). Otherwise (S80: “Y”), i.e. with placed or activated marker, this is prevented and the method or the control device 6 returns directly to step S10.

In the case that in a modification of the marker from step S60 does not prevent the deactivation but merely delays the same by a predetermined time, the automatic start-stop device deactivates the internal combustion engine 1 in step S90 following expiration of this predetermined time.

Although in the preceding description exemplary embodiments were explained it is pointed out that a multiplicity of modifications is possible. Accordingly, other predetermined traffic situations can be taken into account in addition or alternatively to those checked in the steps S20-S50 or as a consequence of these being detected, the deactivation prevented or delayed. Additionally or alternatively, the automatic start-stop device can also detect a different deactivation condition, in step S60 it is also possible to directly return to step S10 and/or step S70 carried out prior to one of the steps S20-S50.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-15. (canceled)

16. A method for the selective deactivation of an internal combustion engine of a motor vehicle by an automatic start-stop device comprising:
detecting a traffic situation of the motor vehicle; and
preventing or delaying the deactivation of the internal combustion engine in the case that the detected traffic situation corresponds to at least one predetermined traffic situation.

17. The method according to claim 16, wherein the traffic situation is detected with at least one optical detector.

18. The method according to claim 17, wherein the traffic situation is detected with a forward-looking camera.

19. The method according to claim 16, further comprising at least one of detecting a brightness for a lighting control of the motor vehicle, detecting a rain condition for a windscreen wiper of the motor vehicle, detecting a road condition for a driver assistance system of the motor vehicle, and detecting a traffic condition for a driver assistance system of the motor vehicle.

20. The method according to claim 16, further comprising detecting the traffic situation with at least one of a navigation system, a GPS system and a communication system of the motor vehicle for communication with at least one of a traffic travelling ahead, a vehicle surroundings, a traffic sign and a guidance system.

21. The method according to claim 16, wherein detecting the traffic situation comprises detecting at least one of a vehicle stopping at or reaching or approaching a predetermined stop or a wait-commanding traffic sign type.

22. The method according to claim 16, wherein detecting the traffic situation comprises detecting at least one of a predetermined traffic situation including a stopping at or reaching or approaching a stop or wait-commanding traffic sign, a traffic light with a variable stop or waiting time, which is shorter than a specified minimum time.

23. The method according to claim 16, wherein at least one predetermined traffic situation comprises a stopping at or reaching or approaching a stop or wait-commanding traffic sign with static stop or wait command, in particular a stop sign.

24. The method according to claim 16, wherein at least one predetermined traffic situation comprises a stopping at or reaching or approaching at least one further road, temporarily having right of way, a road intersection, a junction or a traffic circle.

25. The method according to claim 16, wherein at least one predetermined traffic situation comprises a parking of the motor vehicle.

26. The method according to claim 25, wherein the at least one predetermined traffic situation comprises an intermittent movement of a traffic of the motor vehicle travelling ahead, the stoppage time of which is in particular shorter than a shorter minimum time or brought about by a traffic situation of the traffic travelling ahead.

27. The method according to claim 25, wherein a stoppage time of the internal combustion engine for the at least one predetermined traffic situation is shorter than a specified minimum time.

28. The method according to claim 27, wherein the specified minimum time is adjustable.

29. The method according to claim 27, wherein the specified minimum time is greater than 0 seconds and less than 120 seconds.

30. A control device for the selective deactivation of an internal combustion engine of a motor vehicle comprising an automatic start-stop device configured to:
detect a traffic situation of the motor vehicle; and
prevent or delaying the deactivation of the internal combustion engine when the detected traffic situation corresponds to at least one predetermined traffic situation.

31. A motor vehicle with an internal combustion engine and a control device for the selective deactivation of the internal combustion engine according to claim 16.

32. A computer program product comprising a program code stored on a non-transitory computer-readable medium, which when executed on a microprocessor, is configured to:
detect a traffic situation of the motor vehicle; and
selectively prevent or delay the deactivation of the internal combustion engine in the case that the detected traffic situation corresponds to at least one predetermined traffic situation.
